(19) United States
(12) Patent Application Publication
(10) Pub. No.: US 2005/0242519 A1
(43) Pub. Date: Nov. 3, 2005

(54) Wedge seal

(76) Inventors: Bashir M. Koleilat, Houston, TX (US); David Zollo, Houston, TX (US)

Correspondence Address: WILLIAMS, MORGAN & AMERSON, P.C., 10333 RICHMOND, SUITE 1100, HOUSTON, TX, 77042, US

(21) Appl. No.: 10/835,476

(22) Filed: Apr. 29, 2004

(51) Int. Cl. F02F 5/00

(52) U.S. Cl. 277/434

(57) ABSTRACT

The present invention is directed to an energized wedge seal. In one illustrative embodiment, the device comprises a first component, the first component having a seal recess formed therein, a first seal member and a second seal member, the first and second seal members engaging one another along a sliding tapered interface, and at least one biasing spring positioned in the seal recess, the biasing spring adapted to urge at least one of the first and second seal members along the sliding tapered interface.

### BACKGROUND OF THE INVENTION

1. Field of the Invention

The present invention is generally related to the field of sealing technology, and, more particularly, to a wedge seal.

2. Description of the Related Art

There are many applications where it is desired to form a seal between two components. Selection of the appropriate sealing technique and seal materials can be important depending upon the particular application. Moreover, it is very important that the reliability of the seal established between such components be relatively high, as seal failure can lead to very severe problems, depending upon the application.

By way of example only, within the oil and gas industry, establishing a seal between two components in harsh downhole conditions is often required as a part of performing drilling and producing operations on oil and gas wells. Depending on the particular locale, downhole conditions can be very severe, e.g., very high temperatures and pressures. Additionally, the existence of corrosive materials and/or debris makes providing adequate seals between various components a very challenging undertaking. In some cases, seals are subjected to variable pressure and/or temperature loading cycles. Providing acceptable seals in such environments and applications is a very challenging task.

Seals may be manufactured from a variety of materials. Plastic materials, such as PTFE, may have certain advantages over many elastomer materials, such as higher allowable operating temperatures, greater tensile strength and/or increased wear resistance. However, certain mechanical properties of plastics, such as compression set, have typically precluded the use as fluid seals in certain applications. This is particularly true in applications where the seals are initially pressure-energized, and are then subjected to pressure and/or thermal cycles. Unlike many elastomer seals, plastics do not recover after mechanical or thermal loading to create an initial seal. Thus, a plastic seal may be compromised once the pressure and/or temperature is reduced such that the initial seal is not re-established at the start of the next pressure/temperature cycle.

The present invention is directed to various devices for solving, or at least reducing the effects of, some or all of the aforementioned problems.

### SUMMARY OF THE INVENTION

The present invention is directed to an energized wedge seal. In one illustrative embodiment, the device comprises a first component, the first component having at least a portion of a seal recess formed therein, a first seal member and a second seal member, the first and second seal members engaging one another along a sliding tapered interface, and at least one biasing spring positioned in the seal recess, the biasing spring adapted to urge at least one of the first and second seal members along the sliding tapered interface.

In another illustrative embodiment, the device comprises a first component, the first component having a seal recess formed therein, a first seal member and a second seal member, the first and second seal members engaging one another along a sliding tapered interface, an energizing ring adapted to engage and move the first seal member along the interface with the second seal member, and a biasing spring positioned adjacent the second seal member, the spring adapted to urge the second seal member along the sliding tapered interface with the first seal member.

In yet another illustrative embodiment, the device comprises a first component, the first component having a seal recess formed therein, a first seal member and a second seal member, the first and second seal members engaging one another along a sliding tapered interface having an angle that ranges from approximately 8-15 degrees, a biasing spring positioned in the seal recess, the spring adapted to urge at least one of the first and second seal members along the sliding tapered interface, and a second component, the second seal member having a sealing surface that is adapted to engage a sealing surface on the second seal member.

In a further illustrative embodiment, the device comprises a gasket, the gasket having a plurality of sealing surfaces and a plurality of seal recesses formed in the gasket, a first seal member and a second seal member positioned in each of the recesses, the first and second seal members engaging one another along a sliding tapered interface, and a biasing spring positioned in each of the seal recesses, the spring adapted to urge at least one of the first and second seal members along the sliding tapered interface.

In yet a further illustrative embodiment, the device comprises a first component, a second component, a gasket positioned adjacent the first and second components, the gasket having a plurality of sealing surfaces and first and second seal recesses formed in the gasket, a first seal member and a second seal member positioned in each of the first and second seal recesses, the first and second seal members engaging one another along a sliding tapered interface, and a biasing spring positioned in each of the first and second seal recesses, the spring adapted to urge at least one of the first and second seal members along the sliding tapered interface, wherein a sealing surface of the second seal member in the first seal recess is adapted to engage a sealing surface of the first component and a sealing surface of the second seal member in the second seal recess is adapted to engage a sealing surface on the second component.

### BRIEF DESCRIPTION OF THE DRAWINGS

The invention may be understood by reference to the following description taken in conjunction with the accompanying drawings, in which like reference numerals identify like elements, and in which:

FIG. 1 is a depiction of one illustrative embodiment of the present invention;

FIG. 2 is a depiction of an alternative embodiment of the present invention;

FIGS. 3 and 4 are further alternative embodiments of the present invention;

FIG. 5 is a depiction of yet another illustrative embodiment of the present invention; and

FIG. 6 is an enlarged view of the wedge seal depicted in FIG. 5.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. The relative sizes of the various features depicted in the drawings may be exaggerated or reduced as compared to the size of those features on real world devices. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

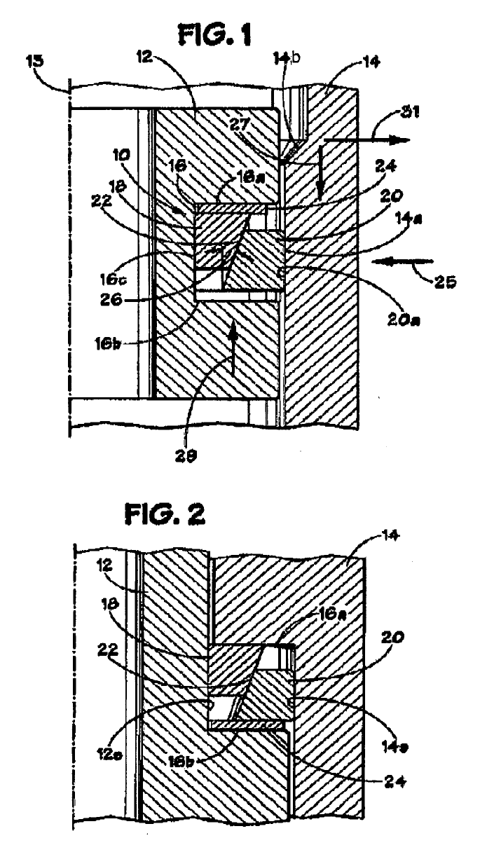

FIG. 1 depicts a wedge seal 10 in accordance with one illustrative embodiment of the present invention. In the embodiment depicted in FIG. 1, the seal 10 is a pressure energized seal in which the sealing force may be generated by the pressurized fluids adjacent the seal 10. As shown therein, the wedge seal 10 provides a sealing interface between a first component 12 and a second component 14. As will be recognized by those skilled in the art after a complete reading of the present application, the components 12, 14 may be any of a variety of different types of components wherein it is desired to establish a sealing interface therebetween. In one illustrative embodiment, the first component 12 may be a hanger, and the second component 14 may be a wellhead. In other embodiments, the first and second components 12, 14 may be tubular components, e.g., pipe. The second component 14 may have a lead-in taper 14b to facilitate the installation of the first component 12. Thus, the present invention should not be considered as limited to any particular components in which the wedge seal 10 of the present invention is employed unless such limitations are expressly set forth in the appended claims. Moreover, the seal 10 of the present invention may be oriented in any direction.

As depicted in FIG. 1, a seal recess or gland 16 is formed in the first component 12. The seal recess 16 is comprised of a first (e.g., top) surface 16a, a second (e.g., bottom) surface 16b and a third (e.g., side) surface 16c. The centerline 13 of the first component 12 is depicted in FIG. 1. The wedge seal 10 further comprises a first seal member 18 and a second seal member 20. The second seal member 20 has a sealing face 20a that is adapted to engage a sealing surface 14a on the second component. The first and second seal members 18, 20 engage one another along a sliding tapered interface 22. The angle 26 of the tapered interface 22 may vary depending upon the particular application. In one illustrative embodiment, the angle 26 of the tapered interface 22 may range between approximately 7 and 15 degrees, and in one particular example may be approximately 11 degrees.

Also depicted in FIG. 1 is a biasing spring 24 that is adapted to provide a biasing force against the first seal member 18, and thereby urge the first seal member 18 along the sliding interface 22 with the second seal member 20. In the depicted embodiment, the biasing spring 24 is positioned in the seal recess 16 between the first seal member 18 and the surface 16a. As shown in FIG. 1, various embodiments of the present invention may employ only a single biasing spring 24. However, other embodiments of the invention may employ a plurality of such biasing springs 24. For example, in addition to the biasing spring 24 shown in FIG. 1, another biasing spring (not shown) may be positioned between the second seal member 20 and the surface 16b. The spring 24 may simply be positioned within the recess 16 at the desired location or it may be secured in place by any of a variety of known techniques, e.g., spot welding.

A variety of biasing springs may be employed with various embodiments of the present invention. For example, the biasing spring may be a wave spring or a belleville (disc) spring. The biasing force provided by the biasing spring 24 may vary depending upon the particular application.

The first and second seal members 18, 20 may be comprised of a variety of different materials. Moreover, the first and second seal members 18, 20 may each be comprised of different materials. For example, the seal members 18, 20 may be comprised of an elastomer or a plastic material. In one illustrative embodiment, both of the seal members 18, 20 are comprised of PEEK (polyether ether ketone).

Assembly of the wedge seal 10 may be accomplished as follows. Initially, the biasing spring 24 is positioned in the seal recess 16. If desired, the biasing spring 24 may be secured to the surface 16a of the seal recess 16 by any of a variety of techniques. Alternatively, the biasing spring 24 may simply be positioned within the recess 16. In one illustrative embodiment, the first seal member 18 is flexible enough such that it may thereafter be stretched over the first component 12 and into the seal recess 16 in the position depicted in FIG. 1. Then, the second seal member 20 is positioned around the first component 12 and positioned within the seal recess 16 such that the first and second seal members 18, 20 are engaged along the tapered sliding interface 22. The first seal member 18 is positioned within the seal recess 16 such that the biasing spring 24 engages a portion of the first seal member 18. In the case where the first component 12 is a hanger and the second component 14 is a wellhead, the hanger 12 may then be positioned within the wellhead 14. As the hanger 12 is positioned downhole, the sealing surface 20a of the second seal member 20 engages the surface 14a of the wellhead 14. In turn, this tends to urge the second seal member 20 radially inward in the direction indicated by the arrow 25 and upward in the direction indicated by the arrow 29 due to the frictional drag exerted on the second seal member 20. The biasing spring 24 tends to counteract this force by applying a biasing force in the direction indicated by the arrow 27, which tends to urge the first seal member 18 downward. The downward movement of the first seal member 18 tend to urge the second seal member 20 outward in the direction indicated by the arrow 31 due to the interaction of the first and second seal members 18, 20 along the tapered interface 22. The various forces generated by the spring 24 and the cooperative movement of the seal members 18, 20 along the tapered interface 22 enable the seal to accommodate fluctuations in the operational environment of the seal 10.

When the wedge seal 10 is subjected to operating conditions downhole, the seal 10 may tend to deform due to various pressure and temperature loadings experienced by the first seal member 18 and/or second seal member 20. Absent the force supplied by the biasing spring 24, such deformations may lead to less than desirable sealing conditions or, in some cases, seal failure. However, due to the presence of the biasing spring 24, the first seal member 18 may be constantly urged downward in the direction indicated by the arrow 27, thereby helping to insure that the seal between the second seal member 20 and the second component 14 is maintained. More specifically, the biasing spring 24 biases the first seal member 18 to slide against the second seal member 20 along the tapered interface 22. This biasing force ultimately urges the seal member 20 against the second component 14 to thereby reset the seal 10. The resetting of the seal 10 creates an initial seal for the start of the next cycle. That is, while the individual seal members 18, 20 may suffer some degree of compression setting, the seal assembly recovers as a whole. Also note that because the seal 10 is energized by the biasing spring 24, the seal 10 is self-resetting, i.e., intervention by outside forces is not needed to reset the seal 10.

FIG. 2 depicts an alternative embodiment of the present invention wherein the seal recess 16 is defined in part by each of the first and second components 12, 14. As depicted therein, the first surface 16a of the seal recess 16 is formed on the second component 14 and the second surface 16b is formed on the first component 12. Each of the first and second components 12, 14 have side surfaces 12s, 14s that define a portion of the seal recess 16. Only a single biasing spring 24 is depicted in FIG. 2. However, as explained above with reference to FIG. 1, the biasing spring 24 may also be positioned between the surface 16a and the seal member 18. In some cases, the present invention may employ a plurality of biasing springs 24. That is, in addition to the biasing spring 24 depicted in FIG. 2, another biasing spring 24 may be provided between the seal member 18 and the surface 16a. In view of the foregoing, it should be understood that the present invention has broad applicability and thus should not be considered as limited to any of the disclosed embodiments or features unless such limitations are specifically recited in the appended claims.

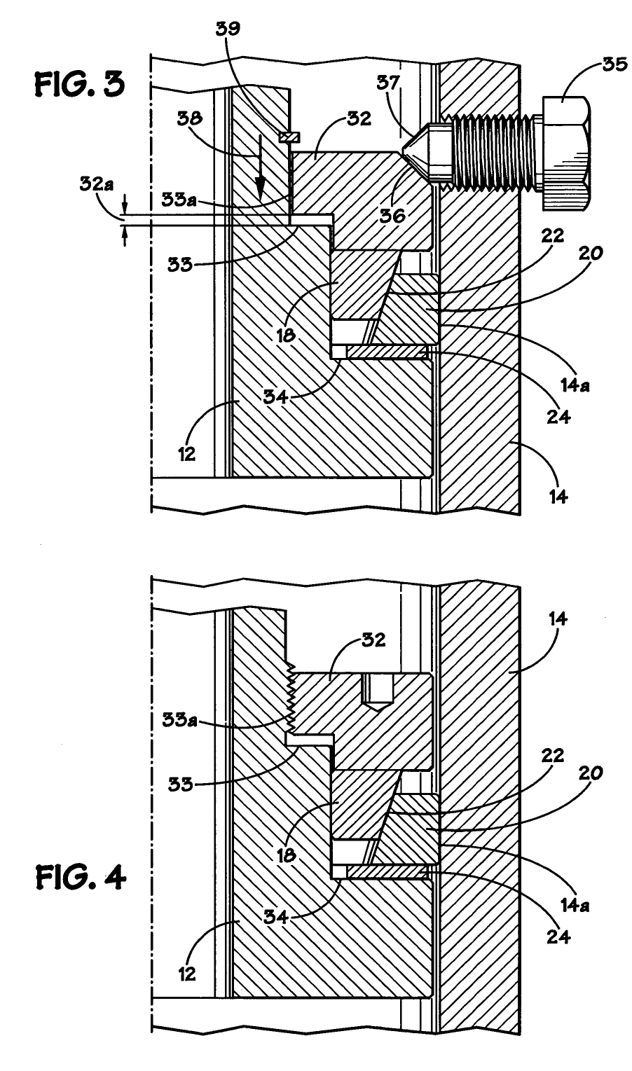

FIG. 3 depicts another illustrative embodiment of the present invention. As shown therein, the first component 12 has two shoulders 33, 34 and the device further comprises an energizing ring 32, a retaining ring 39 and an actuating member 35, e.g., a lockdown screw, operatively coupled to the second component 14. The actuating member 35 has a tapered surface 37 that is adapted to engage a tapered surface 36 formed on the energizing ring 32. Sufficient clearance, as indicated by the arrow 32a, is provided between the energizing ring 32 and the shoulder 33 such that the energizing ring 32 may move when engaged by the actuating member 35. The retaining ring 39 is provided to retain the energizing ring 32 in the position indicated in FIG. 3. Of course, the lockdown screw 35 with the tapered surface 37 is but one example of a means for moving the energizing ring 32 into engagement with one of the seal members.

In operation, the spring 24 and the seal members 20 and 18 are positioned as shown relative to the first component 12. Thereafter, the energizing ring 32 is positioned above the first seal member 18 and the retaining ring 39 is coupled to the first component 12. Next, with the lockdown screw 35 in a retracted position (not shown), the first component 12 is positioned within the opening defined by the second component 14. The lockdown screw 35 is then urged forward such that, in one embodiment, the tapered surface 37 of the lockdown screw 35 engages the tapered surface 36 of the energizing ring 32. The interaction between the tapered surfaces 36, 37 urges the energizing ring 32 downward (in the direction indicated by the arrow 38). In turn, the energizing ring 32 urges the first seal member 18 downward, which, due to the tapered interface 22, urges the second seal member 20 outward to thereby sealingly engage the surface 14a of the second component 14. The various interactions described above create a biasing force in the spring 24 that tends to urge the second seal member 20 upward. In short, in the embodiment of the seal depicted in FIG. 3, the energizing ring 32, the lockdown screw 35 and the biasing spring 24 may be used to energize the seal components.

FIG. 4 depicts yet another illustrative embodiment of the present invention. The embodiment depicted in FIG. 4 is similar to the one depicted in FIG. 3 with the exception that the lockdown screw 35 and the retaining ring 39 are omitted. In the embodiment depicted in FIG. 4, the retaining ring 32 is threadingly coupled to the first component 12 at the surface 33a. In this embodiment, the energizing ring 32 is threadingly coupled to the first component 12 in such a manner so as to create a biasing force in the spring 24 and thereby energize the seal. As thus energized, the seal is adapted to adjust to fluctuations in various operational conditions due to the biasing force created in the spring 24 and the tapered interface 22 between the first and second seal members 18, 20.

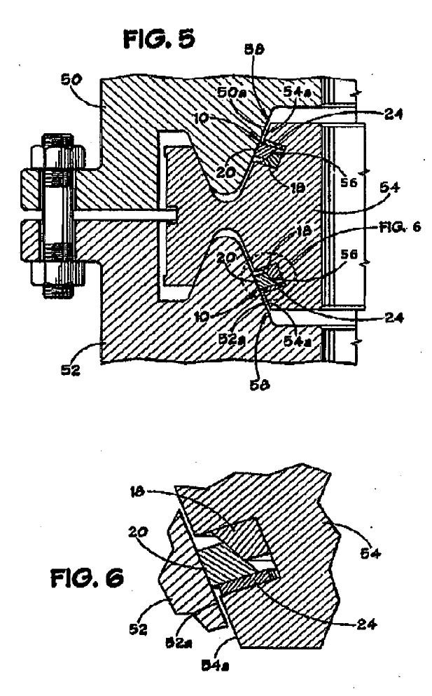

FIGS. 5 and 6 depict yet another illustrative embodiment of the present invention. As shown therein, a plurality of the wedge seals 10 of the present invention are positioned in a gasket 54 that is positioned adjacent two components 50 and 52 that are adapted to be mated to one another. FIG. 6 is an enlarged view of one of the seals 10 depicted in FIG. 5. As before, the components 50, 52 may be any of a variety of different types of components, e.g., wellheads, tubing heads, blowout preventers, valves, valve bonnets, bottom hole assemblies, etc. The components 50, 52 may be coupled to one another by any technique, e.g., bolts and nuts, clamps, etc.

In the illustrative embodiment depicted in FIG. 5, the seal 54 is a metal “AX” gasket that is adapted to provide a seal between the components 50, 52. More specifically, the gasket 54 is comprised of sealing surfaces 54a that are adapted to engage corresponding sealing surfaces 50a and 52a on the components 50, 52, respectively. In the depicted embodiment, the sealing surfaces 54a of the gasket 54 and the sealing surfaces 50a , 52a of the components 50, 52, respectively, are tapered sealing surfaces. The angle of the tapered sealing surfaces 54a, 50a and 52a may vary depending upon the particular application. However, it should be understood that the wedge seal 10 of the present invention may be employed gaskets 54 that have non-tapered sealing surfaces that are adapted to engage non-tapered sealing surfaces on the various sealed components. The arrangement shown in FIGS. 5 and 6 depicts a pressure assisted configuration where the present invention may be employed. In this configuration, the initial sealing force is generated by making up the joint between the two components 50, 52, i.e., the pressurized fluid does not generate the initial seal. The tapered interface between the gasket 54 and the surfaces 50a, 52a creates a mechanical advantage which drives the tapered seal components together. As the sealed pressure increases, the pressurized fluid assists in creating the sealing force.

A plurality of seal recesses or glands 56 are formed in the gasket 54. Each of the recesses 56 are adapted to receive the basic components of the seal 10, e.g., the first seal member 18, the second seal member 20, and the biasing spring 24. As explained previously, a sliding interface 22 exists between the sealing members 18 and 20. The angle of the sealing interface 22 may vary depending upon the particular application. In this particularly illustrative example, the seals 10 of the present invention are secondary or redundant seals to the primary sealing areas between the gasket 54 and the components 50, 52 in the areas generally indicated by the arrows 58, i.e., the sealing areas defined by the engagement of the sealing surfaces 54a, 50a and 52a. However, the present invention should not be considered as limited to being used only as a secondary seal. In some applications, the seal of the present invention may act as a primary seal member.

The present invention is directed to various embodiments comprising a wedge seal. In one illustrative embodiment, the device comprises a first component, the first component having at least a portion of a seal recess formed therein, a first seal member and a second seal member, the first and second seal members engaging one another along a sliding tapered interface, and at least one biasing spring positioned in the seal recess, the biasing spring adapted to urge at least one of the first and second seal members along the sliding tapered interface.

In another illustrative embodiment, the device comprises a first component, the first component having a seal recess formed therein, a first seal member and a second seal member, the first and second seal members engaging one another along a sliding tapered interface, an energizing ring adapted to engage and move the first seal member along the interface with the second seal member, and a biasing spring positioned adjacent the second seal member, the spring adapted to urge the second seal member along the sliding tapered interface with the first seal member.

In yet another illustrative embodiment, the device comprises a first component, the first component having a seal recess formed therein, a first seal member and a second seal member, the first and second seal members engaging one another along a sliding tapered interface having an angle that ranges from approximately 8-15 degrees, a biasing spring positioned in the seal recess, the spring adapted to urge at least one of the first and second seal members along the sliding tapered interface, and a second component, the second seal member having a sealing surface that is adapted to engage a sealing surface on the second seal member.

In a further illustrative embodiment, the device comprises a gasket, the gasket having a plurality of sealing surfaces and a plurality of seal recesses formed in the gasket, a first seal member and a second seal member positioned in each of the recesses, the first and second seal members engaging one another along a sliding tapered interface, and a biasing spring positioned in each of the seal recesses, the spring adapted to urge at least one of the first and second seal members along the sliding tapered interface.

In yet a further illustrative embodiment, the device comprises a first component, a second component, a gasket positioned adjacent the first and second components, the gasket having a plurality of sealing surfaces and first and second seal recesses formed in the gasket, a first seal member and a second seal member positioned in each of the first and second seal recesses, the first and second seal members engaging one another along a sliding tapered interface, and a biasing spring positioned in each of the first and second seal recesses, the spring adapted to urge at least one of the first and second seal members along the sliding tapered interface, wherein a sealing surface of the second seal member in the first seal recess is adapted to engage a sealing surface of the first component and a sealing surface of the second seal member in the second seal recess is adapted to engage a sealing surface on the second component.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A device, comprising:
a first component, said first component having at least a portion of a seal recess formed therein;
a first seal member and a second seal member, said first and second seal members engaging one another along a sliding tapered interface; and
at least one biasing spring positioned in said seal recess, said at least one biasing spring adapted to urge at least one of said first and second seal members along said sliding tapered interface.

2. The device of claim 1, farther comprising a second component, one of said first and second seal members having a sealing surface that is adapted to engage a sealing surface on said second component.

3. The device of claim 1, wherein said first component comprises at least one of a wellbore hanger and a tubular component.

4. The device of claim 1, wherein said second component comprises at least one of a wellhead and a tubular component.

5. The device of claim 1, wherein said first component is a gasket.

6. The device of claim 1, wherein said first and second seal members are comprised of a material selected from the group consisting of a plastic, an elastomer and PEEK.

7. The device of claim 1, wherein said tapered sliding interface is tapered at an angle that ranges from approximately 8-15 degrees.

8. The device of claim 1, wherein said at least one biasing spring is comprised of at least one of a wave spring and a disc spring.

9. The device of claim 1, wherein said seal recess is formed entirely in said first component.

10. The device of claim 1, further comprising an energizing ring adapted to engage and move one of said first and second seal members along said sliding tapered interface.

11. The device of claim 10, further comprising means for moving said energizing ring into engagement with one of said first and second seal members.

12. The device of claim 10, further comprising an actuating member coupled to said second component, a portion of said actuating member adapted to engage a portion of said energizing ring to thereby cause said energizing ring to move.

13. The device of claim 12, wherein said actuating member is a screw member having a tapered surface that is adapted to engage a tapered surface formed on said energizing ring.

14. The device of claim 1, further comprising an energizing ring adapted to engage one of said first and second seal members, said energizing ring being threadingly coupled to said first component.

15. A device, comprising:
a first component, said first component having a seal recess formed therein;
a first seal member and a second seal member, said first and second seal members engaging one another along a sliding tapered interface;
an energizing ring adapted to engage and move said first seal member along said interface with said second seal member; and
a biasing spring positioned adjacent said second seal member, said spring adapted to urge said second seal member along said sliding tapered interface with said first seal member.

16. The device of claim 15, further comprising a second component, said second seal member having a sealing surface that is adapted to engage a sealing surface on said second component.

17. The device of claim 15, wherein said tapered sliding interface is tapered at an angle that ranges from approximately 8-15 degrees.

18. The device of claim 15, wherein said biasing spring is comprised of at least one of a wave-type spring and a disc spring.

19. The device of claim 15, further comprising means for moving said energizing ring into engagement with said first seal member.

20. The device of claim 15, further comprising an actuating member coupled to said second component, a portion of said actuatiing member adapted to engage a portion of said energizing ring to thereby cause said energizing ring to move.

21. The device of claim 20, wherein said actuating member is a screw member having a tapered surface that is adapted to engage a tapered surface formed on said energizing ring.

22. The device of claim 15, wherein said energizing ring is threadingly coupled to said first component.

23. A device, comprising:
a first component, said first component having a seal recess formed therein;
a first seal member and a second seal member, said first and second seal members engaging one another along a sliding tapered interface having an angle that ranges from approximately 8-15 degrees;
a biasing spring positioned in said seal recess, said spring adapted to urge at least one of said first and second seal members along said sliding tapered interface; and
a second component, said second seal member having a sealing surface that is adapted to engage a sealing surface on said second seal member.

24. The device of claim 23, wherein said biasing spring is comprised of at least one of a wave-type spring and a disc spring.

25. The device of claim 23, further comprising an energizing ring adapted to engage and move at least one of said first and second seal members along said sliding tapered interface.

26. The device of claim 25, further comprising means for moving said energizing ring into engagement with said at least one of said first and second seal members.

27. The device of claim 25, further comprising an actuating member coupled to said second component, a portion of said actuating member adapted to engage a portion of said energizing ring to thereby cause said energizing ring to move.

28. The device of claim 27, wherein said actuating member is a screw member having a tapered surface that is adapted to engage a tapered surface formed on said energizing ring.

29. The device of claim 25, wherein said energizing ring is threadingly coupled to said first component.

30. A device, comprising:
a gasket, said gasket having a plurality of sealing surfaces and a plurality of seal recesses formed in said gasket;
a first seal member and a second seal member positioned in each of said recesses, said first and second seal members engaging one another along a sliding tapered interface; and
a biasing spring positioned in each of said seal recesses, said spring adapted to urge at least one of said first and second seal members along said sliding tapered interface.

31. The device of claim 30, further comprising a first component and a second component, said first and second components adapted to have said gasket positioned therebetween, wherein a sealing surface of each of said second seal members is adapted to engage a sealing surface on at least one of said first and second components.

32. The device of claim 30, wherein said first and second seal members are comprised of a material selected from the group consisting of a plastic, an elastomer and PEEK.

33. The device of claim 30, wherein said tapered sliding interface is tapered at an angle that ranges from approximately 8-15 degrees.

34. The device of claim 30, wherein said biasing spring is comprised of at least one of a wave-type spring and a disc spring.

35. A device, comprising:
a first component;
a second component;
a gasket positioned adjacent said first and second components, said gasket having a plurality of sealing surfaces and first and second seal recesses formed in said gasket;
a first seal member and a second seal member positioned in each of said first and second seal recesses, said first and second seal members engaging one another along a sliding tapered interface; and
a biasing spring positioned in each of said first and second seal recesses, said spring adapted to urge at least one of said first and second seal members along said sliding tapered interface, wherein a sealing surface of said second seal member in said first seal recess is adapted to engage a sealing surface of said first component and a sealing surface of said second seal member in said second seal recess is adapted to engage a sealing surface on said second component.

36. The device of claim 35, wherein said tapered sliding interface is tapered at an angle that ranges from approximately 8-15 degrees.

37. The device of claim 35, wherein said biasing spring is comprised of at least one of a wave-type spring and a disc spring.
